(19) United States
(12) Patent Application Publication
(10) Pub. No.: US 2006/0126463 A1
(43) Pub. Date: Jun. 15, 2006

(54) Optical recording and reproducing apparatus

(75) Inventors: Kenji Nakao, Gifu-City (JP); Noboru Mamiya, Daito-City (JP); Ken Hirose, Higasiosaka-City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co., Ltd., Moriguchi-shi (JP)

(21) Appl. No.: 11/294,486

(22) Filed: Dec. 6, 2005

(30) Foreign Application Priority Data
Dec. 9, 2004 (JP) 2004-356594 (P)

(51) Int. Cl. G11B 19/00; G11B 5/09

(52) U.S. Cl. 369/47.5; 369/116; 369/47.55

(57) ABSTRACT

From optimum power set values of Pwp1 and Pwp2 obtained by performing an OPC on Layer 1 and Layer 2, respectively, an interlayer power ratio α=Pwp2/Pwp1 is obtained. In transition from Layer 1 to Layer 2, the last laser power Pwr1 of Layer 1 adjusted by an R-OPC is multiplied by an interlayer power ratio α to set a laser power in transition to Layer 2, at which recording on Layer 2 starts. In this case, the OPC is not necessarily performed in transition from Layer 1 to Layer 2, so transition to Layer 2 can be performed quickly. Also, a correction is performed based on the interlayer power ratio α, so a power can be set to an appropriate set value in transition to Layer 2.

### BACKGROUND OF THE INVENTION

1. Field of the Invention

The present invention relates to an optical recording and reproducing apparatus and more particularly to an optical recording and reproducing apparatus suitably used when information is recorded on and reproduced from an optical recording medium having plural recording layers arranged in its layer direction.

2. Description of the Related Art

Nowadays, various optical recording media such as a CD (Compact Disc) and a DVD (Digital Versatile Disc) are commercialized and widely spread. Among those recording media, in write-once media such as CD-R and DVD-R and rewritable media such as CD-RW and DVD-RW, a process for setting a laser power to an optimum value is performed first (OPC: Optimum Write Power Control), and a recording operation is then executed. For example, in the CD-R or DVD-R, as shown in JP 2002-260230 A for instance, power setting (OPC) is performed following β method. That is, test write is performed at a predetermined power on a power adjustment portion previously set on a disc to obtain a β value from its reproduction RF signal (asymmetry). Then, the obtained β value and a target β value (βt) desired on the disc are compared with each other to set the optimum power at the time of recording.

FIG. 13 shows a calculation method for the β value. As shown in FIG. 13, the β value is obtained by calculating β=(Itop+Ibtm)/(Itop−Ibtm) from asymmetry amplitude values Itop and Ibtm with respect to a reference potential Iref.

The laser power at the test write is set to an initial power previously recorded into a lead-in of the disc or an initial power previously set on the drive side as an initial value. Test write is performed using this initial power Pw1 to obtain the β value, the obtained β value and the target value βt are compared with each other to obtain a laser power Pw2 used at the next test write. Then, test write is performed again using the obtained power Pw2 to further obtain the β value.

When the test write is performed two times, as shown in FIG. 14, the test write is performed using the powers Pw1 and Pw2. The obtained β1 and β2 are subjected to linear approximation, and a laser power at which βt is given is obtained on the approximation line. The obtained laser power is directly set as the optimum laser power or verification is conducted whether the power can be set as the optimum laser power. In the verification, test write is performed using this power again, and an error rate when this test-written data is reproduced is obtained. Then, it is judged whether this error rate is smaller than a threshold, and when the error rate is smaller than the threshold, this laser power is set as the optimum laser power. After that, the recording operation starts at the thus set optimum laser power.

However, during the recording operation, it is necessary to adjust the recording laser power because of change in use environments of a disc or a semiconductor laser, etc. For example, an organic dye is used as a recording layer material in the above-mentioned CD-R, DVD-R, or the like, so a reflectance of the recording layer changes in accordance with a wavelength change. On the other hand, a temperature of the semiconductor laser increases with time after turning ON, and accordingly the wavelength of an output laser beam shifts. Therefore, in a recording media having a wavelength dependence such as the CD-R or the DVD-R, a process for dynamically changing the recording power (R-OPC: Running Optimum Write Power Control) is performed based on a wavelength variation after turning ON the semiconductor laser.

Meanwhile, JP 3096239 B discloses a technique for dynamically changing the set value of the recording power according to the RF signal in recording.

FIG. 15 shows a relation between a recording signal and an RF signal detected during the recording. In FIG. 15, a recording layer is irradiated with a laser beam at a reproducing power level in a recording signal space portion, and the laser power rises to a recording power level in a mark portion. However, immediately after the rise time of the recording power, no marks are formed. Therefore, the same reflection light amount is obtained as an amount obtained when the space portion is irradiated with the laser beam at the recording power level (in this drawing, an RF signal in accordance with the light amount: the same applies hereinafter). After that, when a mark is getting formed along with the temperature increase of the recording layer, a reflection light level (RF signal) accordingly falls down and gradually transits to a reflection level (RF signal) after the mark formation.

Here, if a reflection light level immediately after the rise time of the recording power (in FIG. 15, indicated as “space level”) and a reflection light level in the mark portion (in FIG. 15, indicated as “mark level”) are found out, a degree of modulation of a reflection light intensity can be calculated, and it is possible to monitor a condition of the record mark formation in real time while recording. In view of this, according to JP 3096239 B, the space level and the mark level are detected from the RF signal in recording, and the recording laser power is adjusted based on the degree of modulation of the reflection light intensity (R-OPC: Running OPC).

Incidentally, a disc having plural recording layers arranged on one side has been developed and commercialized recently. For example, JP 2003-346348 A discloses a DVD-R having two recording layers arranged on one side and a drive apparatus for the same.

When one disc surface has plural recording layers arranged thereon in this way, it is necessary to perform the optimum laser power setting process (OPC) and the power adjusting process (R-OPC) in the recording operation for each recording layer.

However, in this case, some information might be recorded continuously across the first recording layer and the second recording layer. When the recording position shifts from the first recording layer to the second recording layer, it is necessary to adjust how the laser power is set. In the CD-R or the DVD-R, such a designing is recommended that recording characteristics for each layer should be balanced, but the recording characteristics for each layer are not necessarily always balanced. When the recording characteristics for each layer are not balanced, if the set value of the laser power applied at the final position of the first recording layer (by the R-OPC) is applied in transition to the second recording layer, the recording characteristics do not conform to the second recording characteristics, which may degrade the recording condition. On the other hand, in transition to the second recording layer, a method of executing the OPC on the second recording layer may be employed, but in this case, a time lag occurs in transition from the first recording layer to the second recording layer, which may disturb smooth recording of real-time data such as video data or audio data in the transition.

### SUMMARY OF THE INVENTION

To solve above-mentioned problems, it is therefore an object to provide an optical recording and reproducing apparatus, capable of quickly and smoothly performing an optimum power setting process even in a transition between recording layers.

According to a first aspect of the present invention, there is provided an optical recording and reproducing apparatus for recording information on an optical recording medium having plural recording layers arranged in a laminating direction and reproducing the information from the optical recording medium, including:laser power setting means for obtaining a ratio α between a laser beam optimum power for a recording layer n and a laser beam optimum power for another recording layer m, and setting, when a recording position transits from the recording layer n to the recording layer m, a power obtained by performing a correction based on the power ratio α on a laser beam power Pwn before the transition as a laser beam power Pwm after the transition.

According to a second aspect of the present invention, there is provided an optical recording and reproducing apparatus for recording information on an optical recording medium having plural recording layers arranged in a laminating direction and reproducing the information from the optical recording medium, including: laser power setting means for obtaining a disparity ΔPa between a laser beam optimum power for a recording layer n and a laser beam optimum power for another recording layer m, and setting, when a recording position transits from the recording layer n to the recording layer m, a power obtained by performing a correction based on the optimum power disparity ΔPa on a laser beam power Pwn before the transition as a laser beam power Pwm after the transition.

According to the first and second aspects of the present invention, the OPC does not need to be executed in transition from the recording layer n to the recording layer m, so the transition to the recording layer m can be quickly performed. Therefore, when real-time data such as video data or audio data is recorded, the continuous recording from the recording layer n to the recording layer m can be performed smoothly. Also, the power obtained by applying the correction based on the optimum power ratio α or the optimum power disparity ΔPa to the laser power Pwn before the transition is set as the laser power Pwm after the transition, so the recording laser power for the recording layer m can be set as the optimum power without error. As a result, the recording condition in the transition can be maintained satisfactorily.

In the respective aspects, for the predetermined recording layer as a target, the laser power setting means can further obtain the ratio γ of the laser beam optimum power between the laser beam optimum power at the recording area start position of the recording layer and the laser beam optimum power at the recording area end position of the recording layer. When the recording position transits from the recording layer n to the recording layer m, the correction based on the ratio γ can be further applied to obtain the laser power Pwm after the transition. Further, instead of this, for the predetermined recording layer as a target, the laser power setting means can further obtain the laser beam optimum power disparity ΔPb between the laser beam optimum power at the recording area start position of the recording layer and the laser beam optimum power at the recording area end position of the recording layer. When the recording position transits from the recording layer n to the recording layer m, the disparity correction based on the disparity ΔPb can be further applied to obtain the laser power Pwm after the transition.

When the laser power setting means is structured in this way, even when there is a difference in recording characteristics between the recording area start position and the recording area end position, the recording laser power can be set as the optimum power at the recording area start position of the recording layer m without error.

Note that the ratio γ and the disparity ΔP can be obtained for the recording layer n or the recording layer m as a target. In this way, the laser power at the recording layer m after the transition can be set more appropriately.

Note that each function of the above-mentioned means is mainly realized by a controller 111 in an embodiment mode described below.

### BRIEF DESCRIPTION OF THE DRAWINGS

The above and further objects and novel features of the invention will be more fully apparent from the following detailed description when the same is read in connection with the accompanying drawings:

FIG. 1 shows a structure of an optical disc according to an embodiment mode;

FIG. 2 shows an area format of the optical disc according to the embodiment mode;

FIG. 3 shows a structure of an optical disc drive according to the embodiment mode;

FIG. 4 is a flowchart of a power setting process according to Embodiment 1;

FIG. 5 is a flowchart of an OPC process for a layer 1 according to Embodiment 1;

FIG. 6 is a flowchart of an OPC process for a layer 2 according to Embodiment 1;

FIG. 7 is a process flowchart at the time of a recording operation according to Embodiment 1;

FIG. 8 is a flowchart of a power setting process according to Embodiment 2;

FIG. 9 is a process flowchart at the time of a recording operation according to Embodiment 2;

FIG. 10 shows an area format of the optical disc according to Embodiment 3;

FIG. 11 a flowchart of a power setting process according to Embodiment 3;

FIG. 12 is a process flowchart at the time of a recording operation according to Embodiment 3;

FIG. 13 is a drawing for explaining a calculation method for a β value;

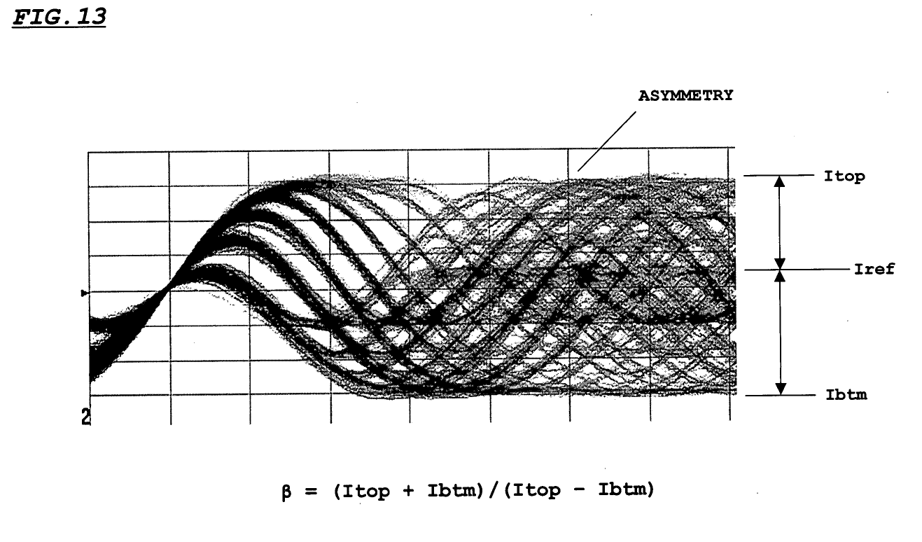

FIG. 14 is a drawing for explaining a calculation method for an approximation line of the β value and an optimum power Pwp; and

FIG. 15 is a drawing for explaining an execution method for an R-OPC.

### DETAILED DESCRIPTION OF THE PREFERRED EMBODIMENTS

Hereinafter, an embodiment mode of the present invention will be described based on the accompanying drawings. Note that this embodiment mode is made by applying the present invention to an optical disc drive for recording and reproducing information on a DVD+R having two recording layers arranged on one side.

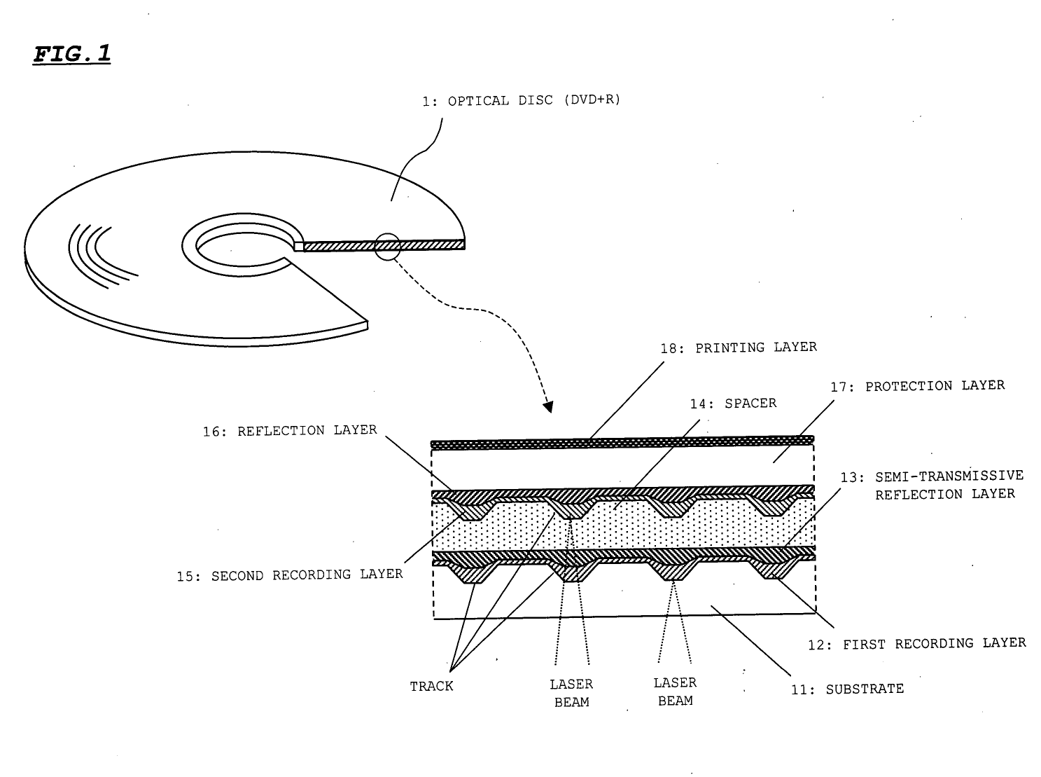

First, FIG. 1 shows a structure of an optical disc according to the embodiment mode. As shown in FIG. 1, an optical disc 1 includes a substrate 11, a first recording layer 12 formed on the substrate 11, a semi-transmissive reflection layer 13 formed on the first recording layer 12, a spacer 14 formed on the semi-transmissive reflection layer 13, a second recording layer 15 formed on the spacer 14, a reflection layer 16 formed on the second recording layer 15, a protection layer 17 formed on the reflection layer 16, and a printing layer 18 formed on the protection layer 17.

Formed on each of the first recording layer 12 and the second recording layer 15 is a spiral track from an inner periphery toward an outer periphery, and data recording and reproducing are performed on this track. Here, the track at the first recording layer 12 and the track at the second recording layer 15 have opposite turn directions. When recording/reproducing the information for the first recording layer 12 and the second recording layer 15, the disc rotates in the same direction. At this time, recording is performed on the first recording layer 12 from the inner periphery toward the outer periphery, and recording is performed on the second recording layer from the outer periphery toward the inner periphery

The track is wobbled in a radius direction, and address information is held by this wobble. That is, a phase modulation interval called ADIP (address in pre-groove) is inserted periodically in a monotone wobble interval. When the phase modulation interval is scanned with a beam, address information on the track is read from a change in its reflection light intensity and reproduced. In ADIP of the lead-in zone, various control data for the disc is recorded through phase modulation, which includes identification information of a disc manufacturer (manufacturer ID) which has manufactured the disc.

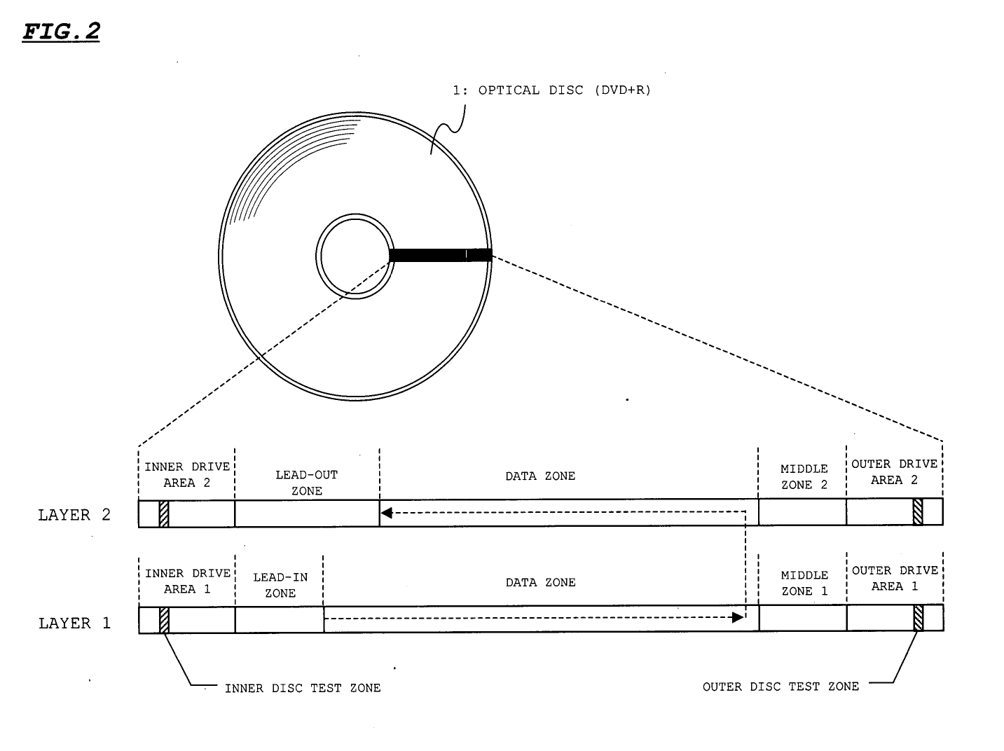

FIG. 2 shows an area format of the optical disc 1.

As shown in FIG. 2, the first recording layer 12 (Layer 1) is divided into, from the inner periphery toward the outer periphery, an inner drive area 1, a lead-in zone, a data zone, a middle zone 1, and an outer drive area 1. The second recording layer 15 (Layer 2) is divided into, from the inner periphery toward the outer periphery, an inner drive area 2, a lead-out zone, a data zone, a middle zone 2, and an outer drive area 2. Further, the inner drive areas 1 and 2 and the outer drive area 1 and 2 are divided into various zones, in which a laser power initial setting (OPC) is performed using an inner disc test zone and an outer disc test zone.

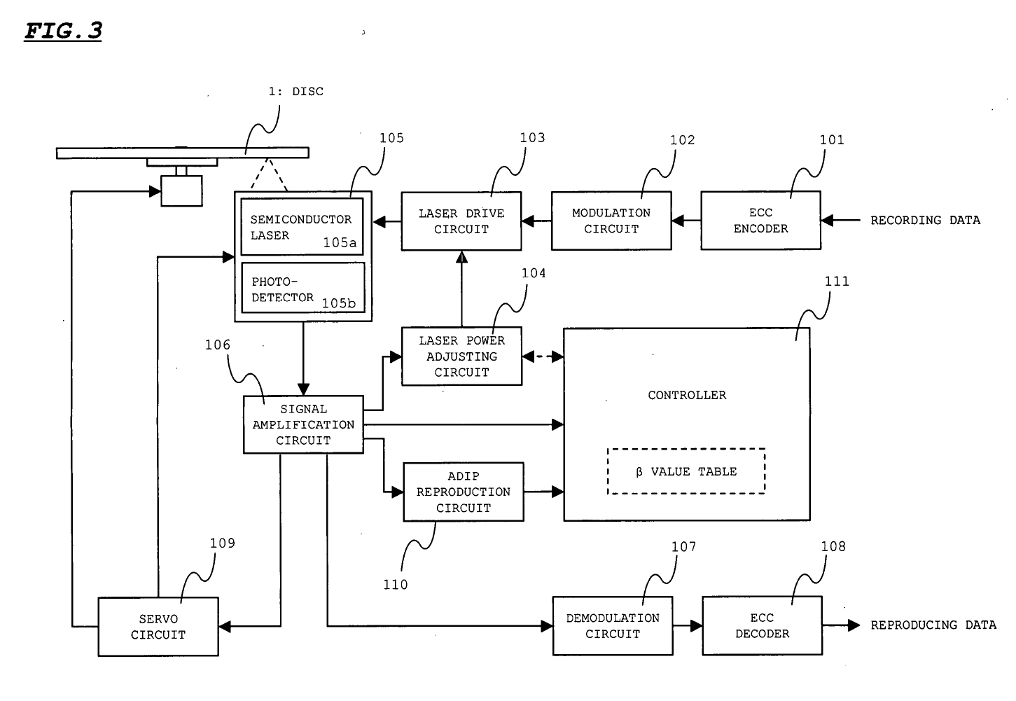

FIG. 3 shows a structure of the optical disc drive according to the embodiment mode.

As shown in FIG. 3, the optical disc drive includes an ECC encoder 101, a modulation circuit 102, a laser drive circuit 103, a laser power adjusting circuit 104, an optical pickup 105, a signal amplification circuit 106, a demodulation circuit 107, an ECC decoder 108, a servo circuit 109, an ADIP reproduction circuit 110, and a controller 111.

The ECC encoder 101 performs an encode processing such as addition of an error-correcting code on the input recording data, and outputs the resultant data to the modulation circuit 102. The modulation circuit 102 performs a predetermined modulation on the input recording data to further generate a recording signal to be output to the laser drive circuit 103. The laser drive circuit 103 outputs a drive signal in accordance with the recording signal from the modulation circuit 102 to a semiconductor laser 105a in recording, and outputs a drive signal for outputting a laser beam at a constant intensity to the semiconductor laser 105a in reproducing. Here, the laser power is set to a laser power adjusted and set by laser power adjusting circuit 104.

The laser power adjusting circuit 104 performs the initial setting (OPC) for the laser power in recording and reproducing in accordance with the set value supplied from the controller 111, appropriately adjusts (R-OPC) the set laser power in accordance with the adjusted value supplied from the controller 111, and supplies the adjusted laser power to the laser drive circuit 103. Here, the laser power initial setting (OPC) is performed based on a target β value (βt) of the disc of interest. That is, the controller 111 obtains the target β value (βt) of the disc, and sets the recording laser power to the optimum power for the disc based on the obtained βt. The detail of the OPC will be described later.

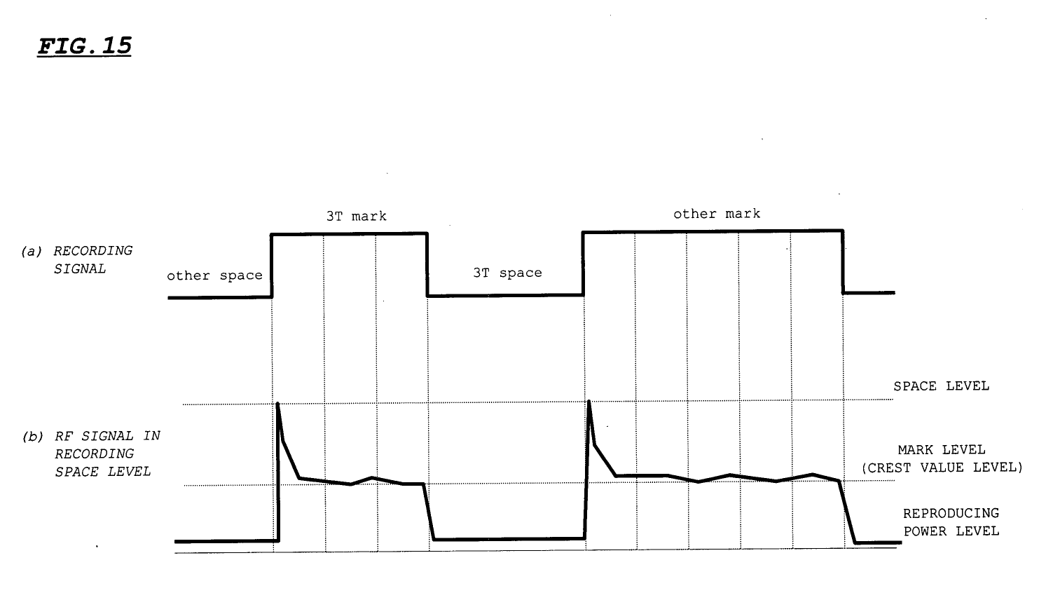

The laser power adjustment (R-OPC) is performed by, for example, as described in FIG. 15, detecting the space level and the mark level from the RF signal in recording and obtaining the degree of modulation of the reflection light intensity to control the obtained degree of modulation so as to follow the degree of modulation at the optimum power.

Note that in recording, the track is irradiated with a pulsed laser beam having plural stages of intensity levels. That is, the laser power adjusting circuit 104 controls the laser drive circuit 103 so that a laser beam having a previously specified pulse shape (strategy) is output from the optical pickup 105. Layer 1 and Layer 2 have different strategies, and therefore Layer 1 and Layer 2 are adjusted to have the same sensitivity to the laser beam. Information on the strategies of Layer 1 and Layer 2 is included in the ADIP of the lead-in zone. The laser power adjusting circuit 104 sets the strategies of Layer 1 and Layer 2 in the recording operation based on the information on the strategies.

The optical pickup 105 includes the semiconductor laser 105a and a photo-detector 105b, and performs write/read of data for the disc through convergence of the laser beam on the track. Note that the optical pickup 105 further includes an objective lens actuator for adjusting the irradiation condition of the laser beam for the track, an optical system for guiding the laser beam output from the semiconductor laser 105 to the objective lens and guiding the reflection light from the disc 100 to the photo-detector 105b, etc.

The signal amplification circuit 106 generates various signals by amplifying and computing the signals received from the photo-detector 105b to output them to the corresponding circuits. The demodulation circuit 107 generates reproduction data by demodulating the reproduction RF signal input from the signal amplification circuit 106 and outputs the reproduction data to the ECC decoder 108. The ECC decoder 108 performs a decoding process such as error correction to the data input from the demodulation circuit 107 and outputs the resultant data to the subsequent circuit.

The servo circuit 109 generates a focus servo signal and a tracking servo signal from a focus error signal and a tracking error signal input from the signal amplification circuit 106 and outputs the generated signals to the objective lens actuator of the optical pickup 105. Also, the servo circuit 109 generates a motor servo signal from a wobble signal input from the signal amplification circuit 106 and outputs the generated signal to a disc drive motor.

The ADIP reproduction circuit 110 reproduces address information and various control information from the wobble signal input from the signal amplification circuit 106 and outputs the reproduced information to the controller 111.

The controller 111 stores various data in a built-in memory while controlling each part in accordance with the previously set program.

Note that the controller 111 holds a β value table in which the manufacturer ID is associated with the target β value (βt). The controller 111 refers to the β value table to read out the target β value (βt) corresponding to the manufacture ID obtained from the lead-in zone (ADIP) of the disc, and outputs the read value to the laser power adjusting circuit 104. According to this value, the laser power adjusting circuit 104 performs the recording laser power initial setting.

### Embodiment 1

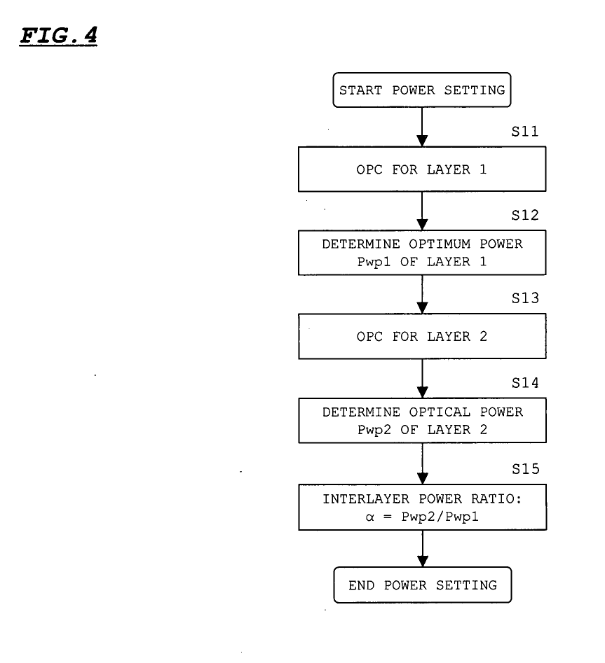

FIGS. 4 to 7 are operation flowcharts showing the OPC and R-OPC in the recording operation.

When a recording instruction is input, the controller 111 first performs the power setting process (OPC) shown in FIG. 4. Here, the OPC for Layer 1 is executed first (S11) to set the optimum power Pwp1 for Layer 1 (S12). Then, the OPC for Layer 2 is executed (S13), to set the optimum power Pwp2 for Layer 2 (S14). Thereafter, the optimum power ratio (interlayer power ratio) α between Layer 1 and Layer 2 is obtained by calculating α=Pwp2/Pwp1 (S15)

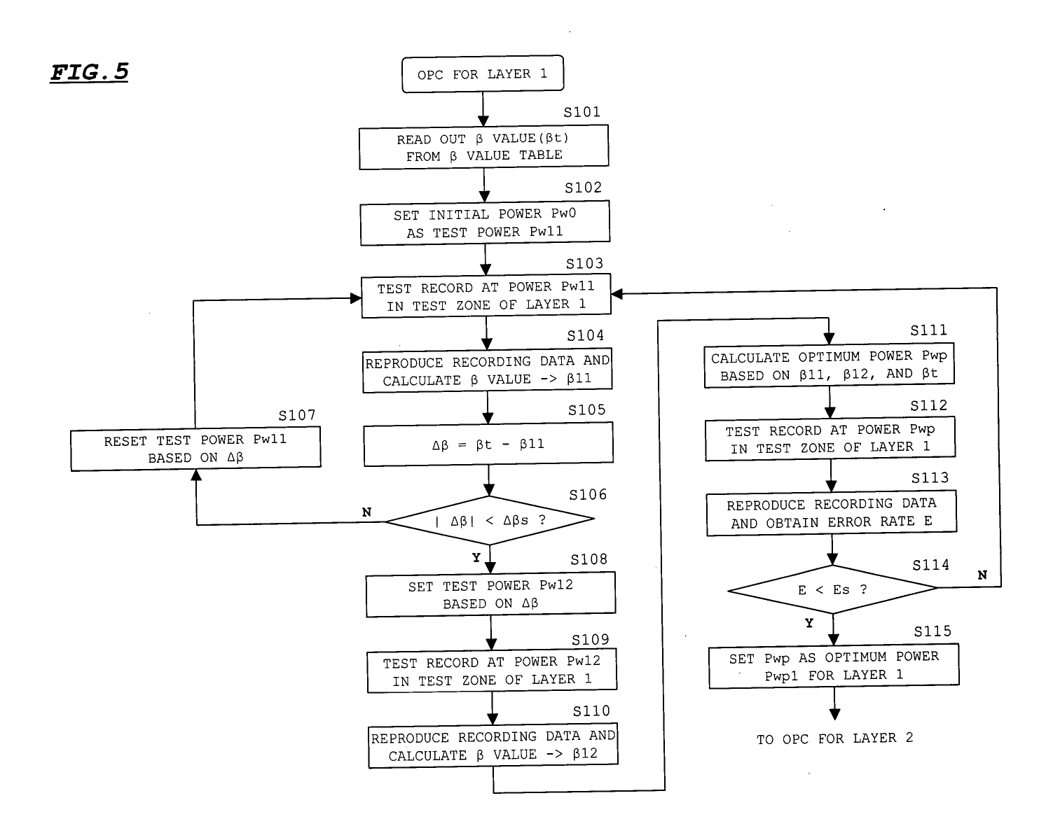

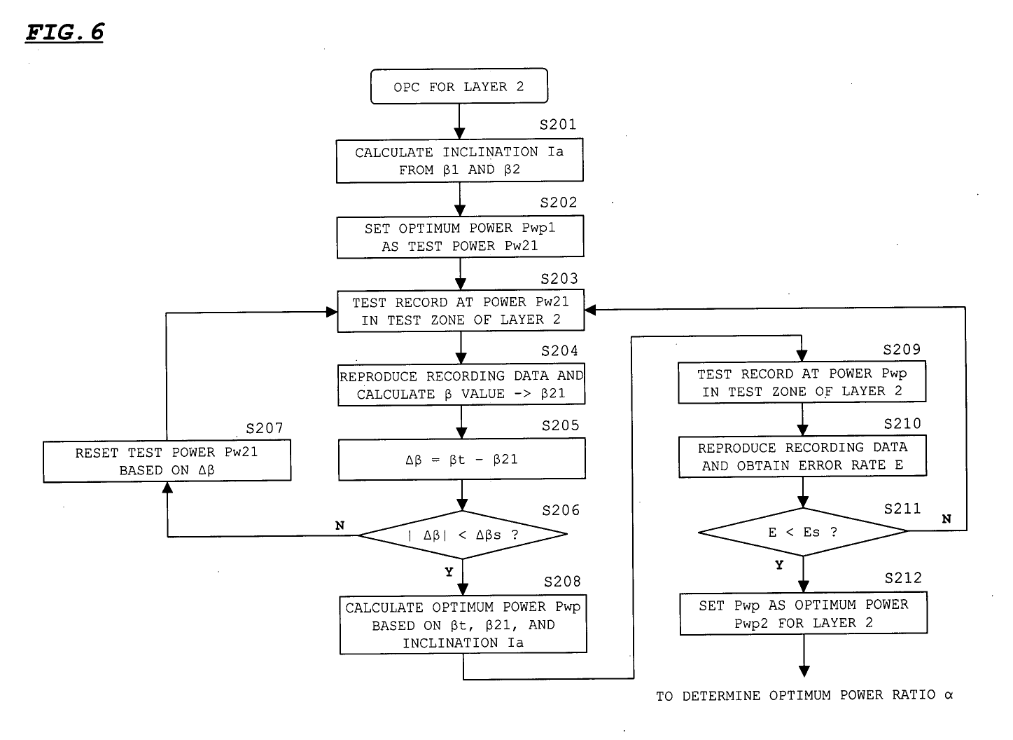

FIGS. 5 and 6 show the details of the OPC for Layer 1 and Layer 2.

First, referring to FIG. 5, when the initial power setting operation starts, the controller 111 reads out the target β value (βt) from the β value table based on the manufacturer ID of the disc (S101) Note that when the corresponding manufacturer ID is not included in the β value table, the average β value is read out from the β value table. To cope with such cases, the β value table stores an average β value for general use.

Further, the controller 111 sets the initial power Pw0 previously stored in the built-in memory as the first test power Pw11 in the OPC operation for Layer 1 (S102), and at the test power Pw11, test data is written to the test zone of Layer 1 (usually, the inner disc test zone is used) (S103). Then, the written test data is reproduced to calculate the β value, and set the calculated β value as β11 (S104).

Thereafter, the controller 111 obtains a difference Δβ between β11 and the target β value (βt) (S105), and judges whether the obtained Δβ is smaller than the predetermined threshold βs (S106). Here, when |Δβ|≧βt, based on the sign (positive or negative) and the magnitude of Δβ, the test power Pw11 is reset to be close to the optimum power (S107), and the process of S103 and the subsequent steps is repeated at the test power Pw11 after the resetting.

On the other hand, when |Δβ|<βt, based on the sign (positive or negative) and the magnitude of Δβ, the next test power Fw12 is set (S108), and at the test power Fw12 after the setting, similarly to the above, test data is written in the test zone of Layer 1 (S109). Then, the written test data is reproduced to calculate the β value, and the calculated β value is set as β12 (S110).

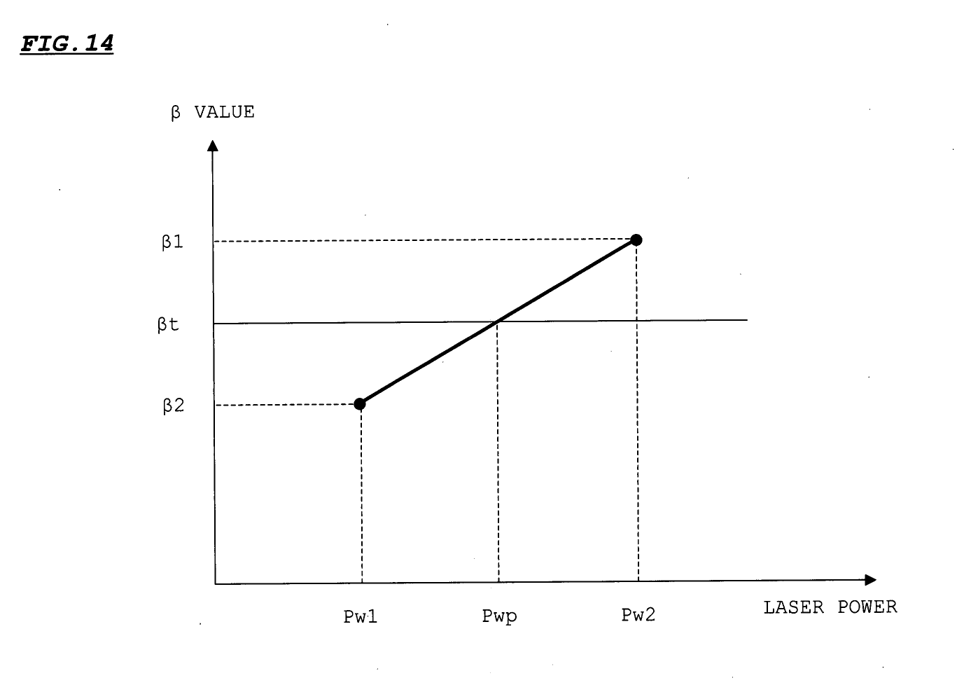

Thereafter, the controller 111 performs linear approximation of β11 and β12 as shown in FIG. 14, and on this approximation line, the laser power for giving the target β value (it) is calculated as the optimum power Pwp (S111). Next, at the power Pwp, test data is written to the test zone of Layer 1 (S112), and further, an error rate E obtained when this data is reproduced is obtained from the ECC decoder 108 (S113). Then, it is judged whether the obtained error rate E is smaller than the threshold Es (S114), and when it is not smaller than the threshold Es, the flow returns to S103 to repeat the above process. On the other hand, when E<Es, the power Pwp is set as the optimum power Pwp1 of Layer 1 (S115), and thereafter the power setting process for Layer 2 is performed.

Referring to FIG. 6, in the power setting process for Layer 2, first, an incline Ia of the approximation line shown in FIG. 14 is obtained from the previously obtained β1 and β2 (S201). Next, the optimum power Pwp1 for Layer 1 as described above is set as the test power Pw21 for Layer 2 in the OPC operation (S202), and at the test power Pw21, test data is written to the test zone of Layer 2 (usually, the inner disc zone is used) (S203). Then, the written test data is reproduced to calculate the β value, and the calculated β value is set as β21 (S204).

After that, the controller 111 obtains a difference Δβ between β21 and the target β value (βt) (S205), and it is judged whether the obtained Δβ is smaller than the predetermined threshold Δβs (S206). Here, when |Δβ≧βs, based on the sign (positive or negative) and the magnitude of Δβ, the test power Pw21 is reset to be close to the optimum power (S207), the process of S203 and the subsequent steps is repeated at the test power Pw21.

On the other hand, when |Δβ|<βs, the approximation line is obtained from the inclination Ia obtained in S201 and β21, and on this approximation line, the laser power for providing the target β value (βt) is set as the optimum power Pwp (S208). Next, at the power Pwp, test data is written to the test zone of Layer 2 (S209), and further, the error rate E obtained when this data is reproduced is obtained from the ECC decoder 108 (S210). Then, it is judged whether the obtained error rate E is smaller than the threshold Es (S211), when the obtained error rate E is not smaller than the threshold Es, the flow returns to S203 to repeat the above process. On the other hand, when E<Es, the power Pwp is set as the optimum power Pwp2 for Layer 2 (S212), and the OPC operation for the disc ends.

Based on the flowchart of FIG. 6, in the OPC operation for Layer 2, calculation of the approximation line can be performed by one time of test record only, so the OPC operation for Layer 2 can be simplified and performed quickly. At this time, as the optimum power Pwp1 for Layer 1 is set as the initial power to obtain the β value, the β value can approach the target β value (it), and the approximation line can be made similar to the predetermined approximation line. Therefore, as described above, when the test record is performed only once in the OPC operation, the optimum power setting for Layer 2 can be performed smoothly and satisfactorily.

In this way, the optimum power Pwp1 for Layer 1 and the optimum power Pwp2 for Layer 2 are set, and further, the interlayer power ratio α is obtained from the Pwp1 and Pwp2, the recording operation for each layer starts.

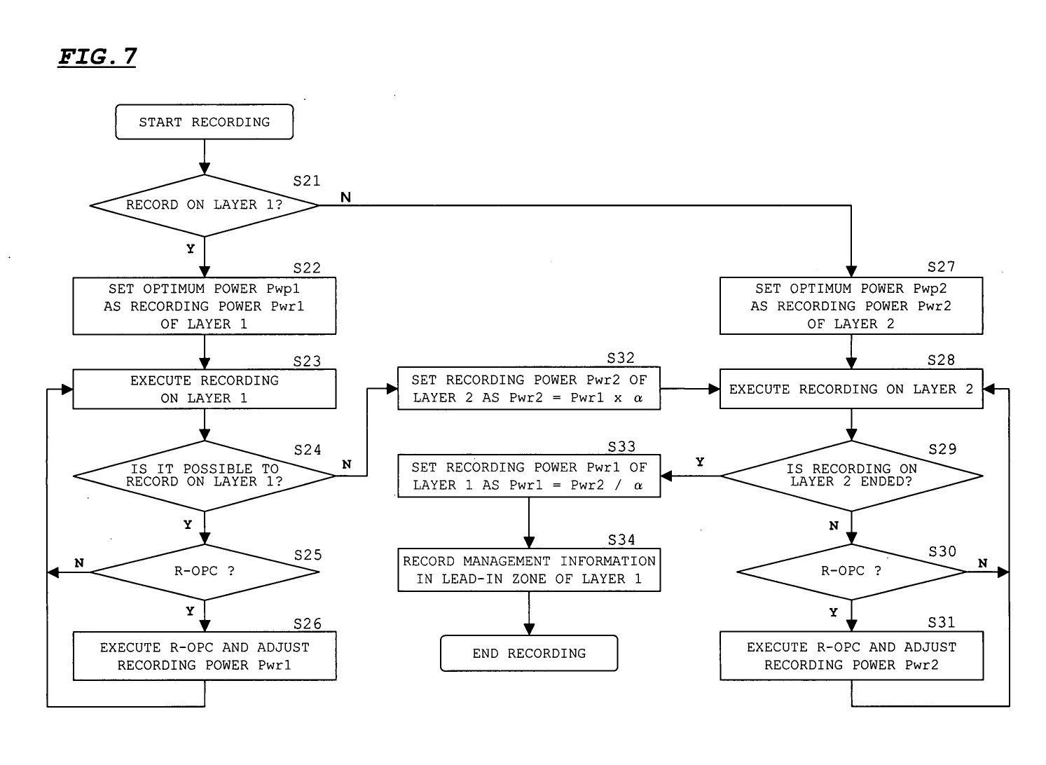

FIG. 7 shows a process flow at the recording operation.

When the recording operation starts, first, management information is read out from the lead-in zone to judge whether the recording start position is at Layer 1 or Layer 2 (S21). Here, when the start position is at Layer 1, the optimum power Pwp1 of Layer 1 obtained by the OPC is set as the recording power Pwr1 of Layer 1 (S22), and thereafter recording of information is successively performed from the recording start position on Layer 1 (S23).

When the recording operation for Layer 1 starts in this way, thereafter, subsequently, it is judged that the recording area of Layer 1 is used up (S24). When the recording area is not used up, adjustment of the laser power Pwr1 by the R-OPC is further performed (S25, S26). Note that, during the recording operation from S23 to S26, when an instruction command indicating stop, interruption, or the like of the recording operation is input to the controller 111, the recording operation for Layer 1 ends in response to this. In this case, at the laser power Pwr1 adjusted by the R-OPC, management information corresponding to the recording is recorded to the lead-in zone.

Based on the judgment in S21, when the recording start position is on Layer 2, the optimum power Pwp2 of Layer 2 obtained by the OPC is the recording power Pwr2 for Layer 2 (S27), and thereafter recording of information starts from the recording start position on Layer 2 subsequently (S28). At this time, judgment whether recording on Layer 2 ends is appropriately performed (S29). Also, after the recording starts for Layer 2, the laser power Pwf2 is appropriately adjusted by the R-OPC (S30, S31).

Based on the judgment in step S24, when the recording area of Layer 1 is used up, the operation shifts to the recording operation using Layer 2. At this time, the power is calculated by multiplying the last laser power Pwr1 for Layer 1 adjusted by the R-OPC by the interlayer power ratio α, and the calculated power is set as the recording power Pwr2 for Layer 2 (S32). Then, recording on Layer 2 starts at the power Pwr2 (S28). Note that this recording is performed from the outermost peripheral position of Layer 2 to the innermost peripheral position as described above.

Thereafter, when it is judged in S29 that the recording on Layer 2 ends, management information for the lead-in zone of Layer 1 is recorded. At this time, the power is calculated by dividing the last laser power Pwr2 for Layer 2 adjusted by the R-OPC by the interlayer power ratio α, and the calculated power is set as the power Pwr1 for Layer 1 in the recording on the lead-in zone (S33). Then, at the power Pwr1, management information in accordance with the recording is recorded to the lead-in zone of Layer 1 (S34), and the recording operation ends.

According to this embodiment, in transition from Layer 1 to Layer 2, the OPC is not necessarily performed, so the transition to Layer 2 can be quickly performed. Thus, even when real-time data such as video data or audio data is recorded, continuous recording from Layer 1 to Layer 2 can be performed smoothly. Also, the power obtained by multiplying the last laser power Pwr1 of Layer 1 by the interlayer power ratio α is set as the laser power Pwr2 in transition to Layer 2, so the recording laser power for Layer 2 can be set as the optimum power without error. Thus, the recording condition in the transition can be maintained to a satisfactory condition.

### Embodiment 2

In Embodiment 1 described above, the last laser power Pwr1 of Layer 1 is multiplied by the interlayer power ratio α to obtain the laser power Pwr2 in transition to Layer 2, but in this embodiment, the power disparity ΔPa between the optimum power Pwp1 of Layer 1 and the optimum power Pwp2 of Layer 2 is obtained. Then, the power disparity is added to the last laser power Pwf1 of Layer 1 to obtain the laser power Pwr2 in transition to Layer 2.

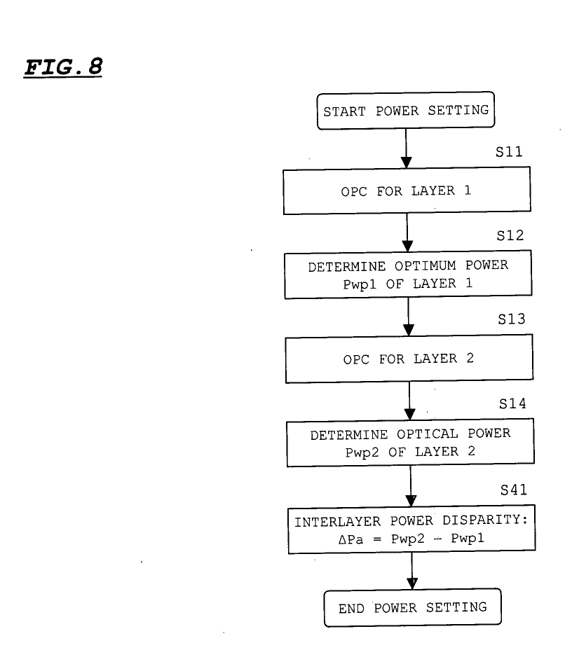

FIG. 8 shows a process flow in the power setting. According to this process flow, S15 is replaced by S41 in the process flow of FIG. 4. In other words, in S41, a power disparity (the interlayer power disparity) ΔPa between the optimum power Pwp1 of Layer 1 and the optimum power Pwp2 of Layer 2 can be obtained from ΔPa=Pwp2−Pwp1. Other steps are similar to those of FIG. 4.

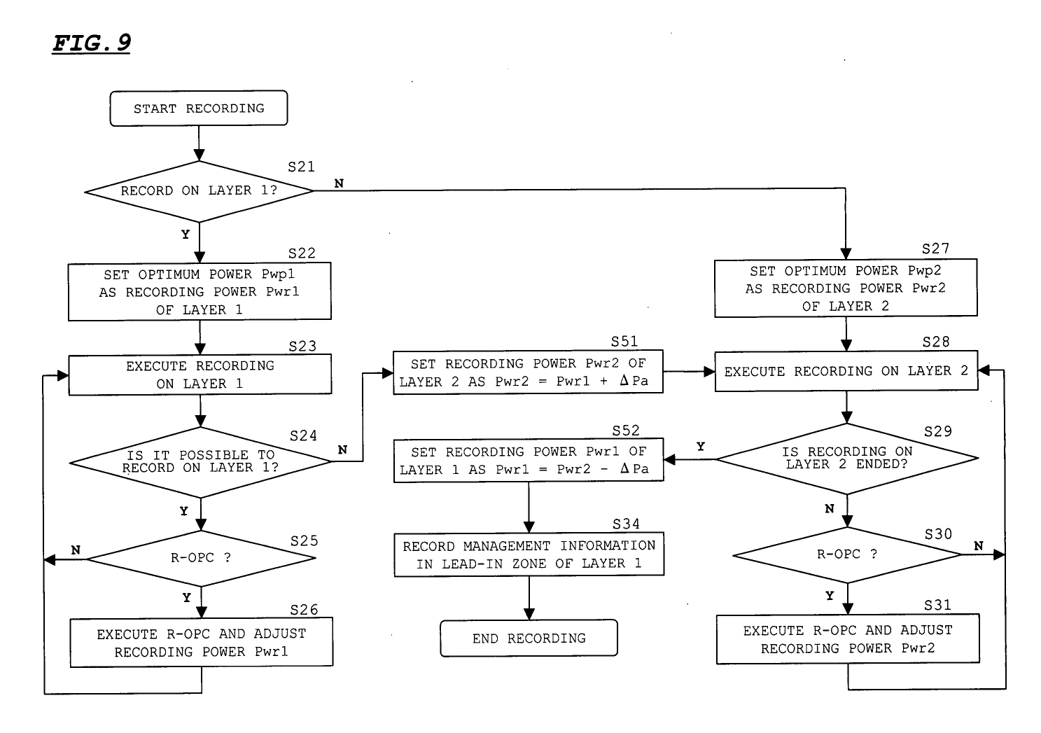

FIG. 9 shows a process flow in the recording operation. According to this process flow, S32 and S33 are replaced by S51 and S52 in the process flow of FIG. 7. In other words, when judged that the recording area of Layer 1 is used up in S24, the interlayer power disparity ΔPa is added to the last laser power Pwr1 of Layer 1 in S51, and the laser power Pwr2 in transition to Layer 2 can be set. Then, recording is performed at the set laser power Pwr2 for Layer 2 (S28). Other steps are similar to those of FIG. 7.

According to this embodiment, because the OPC is not necessarily performed in transition from Layer 1 to Layer 2, similarly to Embodiment 1, the transition to Layer 2 can be performed quickly. Therefore, even when real-time data such as video data or audio data is recorded, continuous recording from Layer 1 to Layer 2 can be performed smoothly. However, to set the recording laser power for Layer 2 as the optimum power without error, it is assumed that multiplication of the interlayer power ratio α as in Embodiment 1 is preferred to addition of the interlayer power disparity ΔPa as in this embodiment.

### Embodiment 3

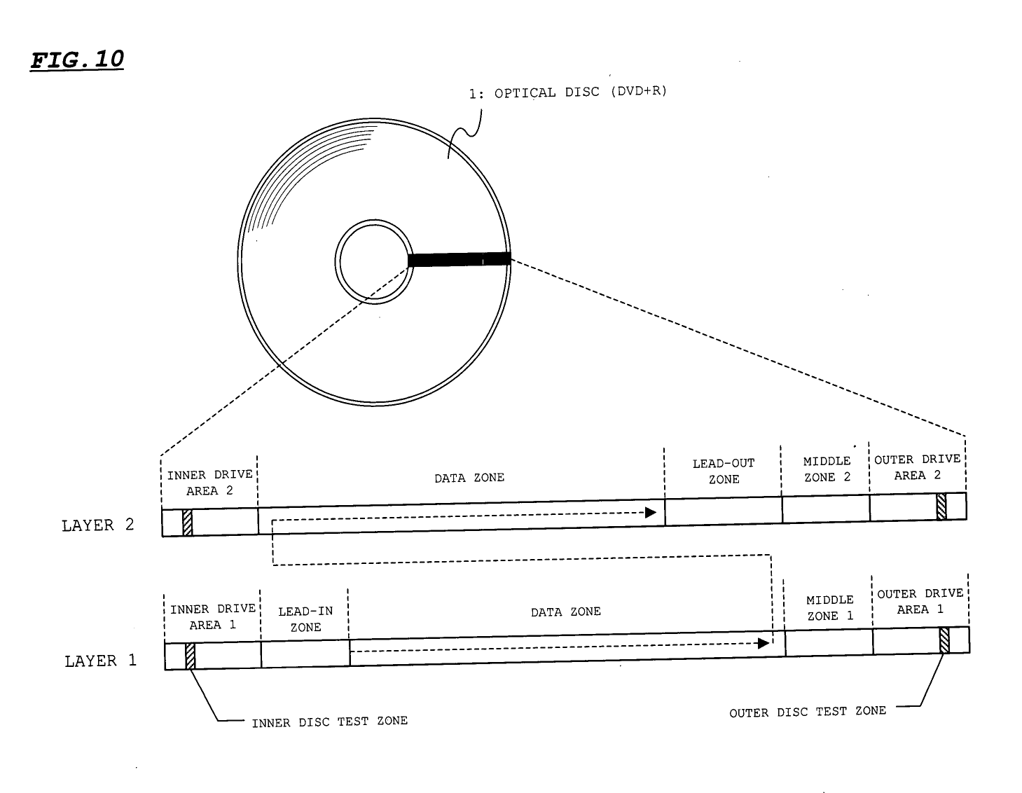

According to Embodiments 1 and 2, as shown in FIG. 2, when the recording position reaches the outermost peripheral position in the data zone of Layer 1 (recording area), the position skips to the outermost peripheral position in the data zone of Layer 2, and data recording starts therefrom toward the inner peripheral direction. However, as shown in FIG. 10, such optical disc can be assumed that the position skips to the innermost peripheral position in the data zone of Layer 2 when the recording position reaches the outermost peripheral position in the zone area of Layer 1 (recording area) and therefrom data is recorded toward the outer periphery. In this optical disc, when the rotation directions in the recording operation are the same, and the spiral direction of the track of Layer 1 is the same as that of Layer 2.

This embodiment is an exemplified mode of applying the present invention to the optical disc drive for recording and reproducing the information on such optical disc.

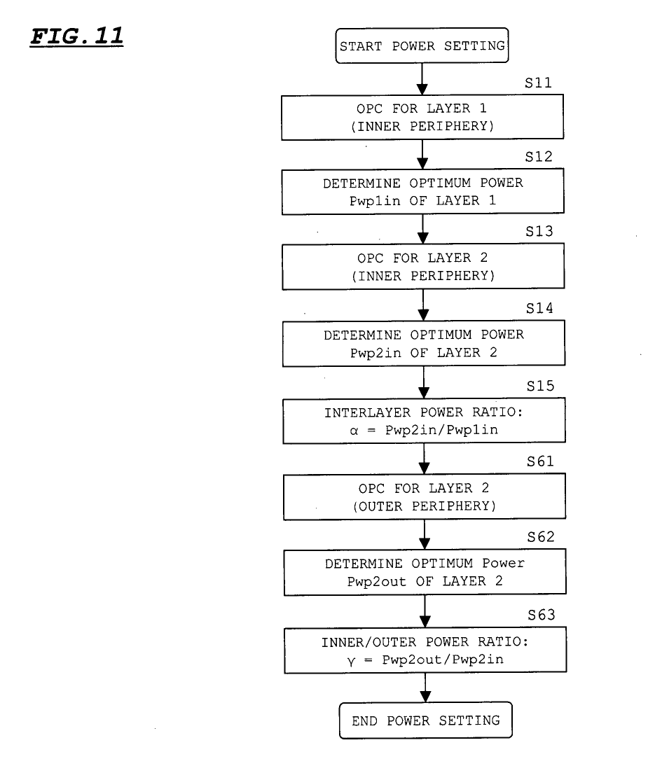

FIG. 11 shows a process flow in the power setting.

According to this process flow, a process of S61 to S63 is added after S15 in the process flow of FIG. 4. In other words, the OPC is executed using the inner disc test zones of Layer 1 and Layer 2 (S11 to S14), the interlayer power ratio α is obtained based on the optimum laser power Pwp1in and Pwp2in obtained by the OPC (S15), and further, the OPC is executed using the outer disc test zone of Layer 2 (S61), the optimum laser power Pwp2out is obtained (S62) Then, based on the optimum laser power Pwr2in and Pwp2out for Layer 2, γ=Pwp2out/pwp2in is computed to obtain an internal/external power ratio γ (S63).

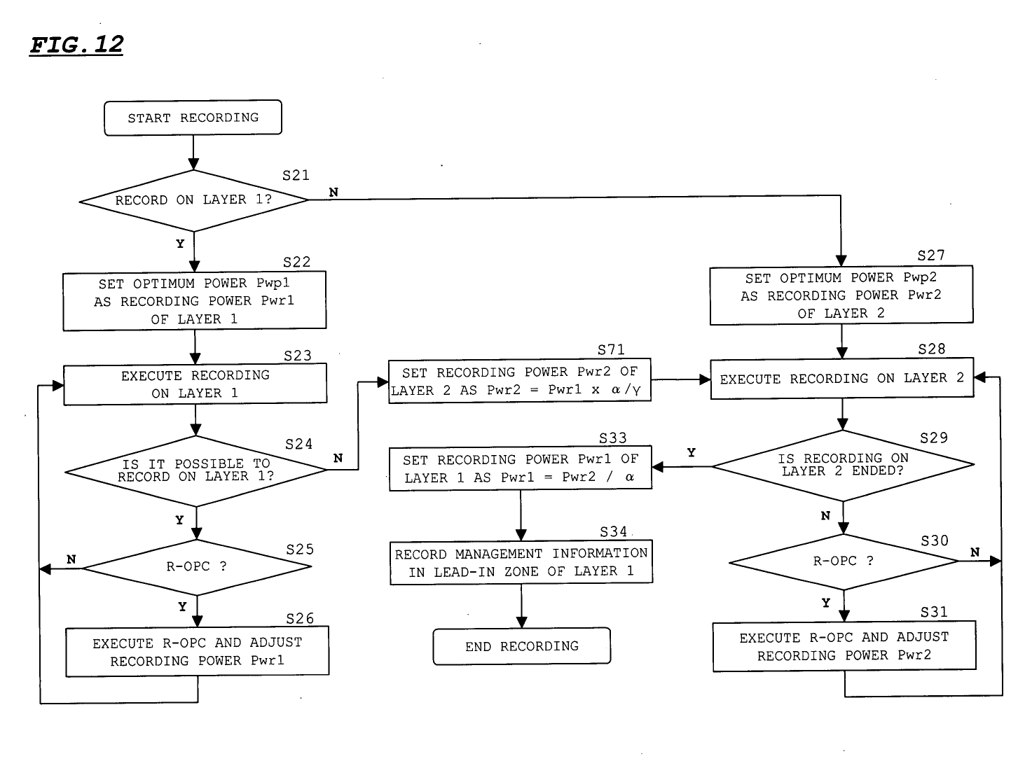

FIG. 12 shows a process flowchart in the recording operation. According to this process flow, S32 in the process flow of FIG. 7 is replaced by S71. In other words, when judged that the recording area of Layer 1 is used up in S24, the last laser power Pwr1 of Layer 1 is multiplied by the interlayer power ratio α in S72. This value is divided by the internal/external power ratio γ to set the laser power Pwr2 in transition to Layer 2. Then, at the set laser power Pwr2, recording on Layer 2 is performed (S28). The other steps are similar to those of FIG. 7.

According to this embodiment, in transition from Layer 1 to Layer 2, the OPC is not necessarily performed similarly to Embodiments 1 and 2, so the transition to Layer 2 can be performed quickly. Thus, even when real-time data such as video data or audio data is recorded, continuous recording from Layer 1 to Layer 2 can be performed smoothly.

Also, the last laser power Pwr1 of Layer 1 is multiplied by the interlayer power ratio α, and further, the power obtained by dividing this value by the internal/external power ratio γ to be set as the laser power Pwr2 in transition to Layer 2, so the recording laser power for Layer 2 can be set as the optimum power without error. In other words, but in this embodiment, the recording power is further adjusted at the internal/external power ratio γ. Even when there is a difference in recording characteristics between the inner periphery and outer periphery of Layer 2, the recording laser power can be set as the optimum power in the start position of Layer 2 without error. Thus, the recording condition in the transition can be maintained in a satisfactory condition.

Note that, as shown in FIG. 9, even when the recording position skips from the outer periphery of Layer 1 to the inter periphery of Layer 2, if there is no large difference in the recording characteristics in Layer 2, while adjustment using the inter/outer power disparity γ is not performed, the recording laser power can be set as the optimum power in the start position of Layer 2 without error. Therefore, in this case, as in Embodiment 1, only the interlayer power ratio α may be multiplied for performing the power setting in transition to Layer 2.

Further, in this embodiment, the last laser power Pwr1 of Layer 1 is multiplied by the interlayer power ratio α, and further, the power obtained by dividing this value by the internal/external power ratio γ is set as the laser power Pwr2 in transition to Layer 2 (S71), but as in Embodiment 2, when using the interlayer power disparity ΔPa, the arithmetic expression in S71 may be changed to Pwr2=(Pwr1+ΔPa)/γ.

Further, when the internal/external power disparity ΔPb=Pwp2in−Pwp2out is used instead of the internal/external power ratio γ, the arithmetic expression in S71 may be changed to Pwr2=(pwr1×α)+ΔPb.

Further, in this embodiment, the internal/external power ratio γ in Layer 2 is obtained to be used for the power setting in transition to Layer 2, but the internal/external power ratio γ in Layer 1 may be obtained and be used for the power setting in transition to Layer 2.

Moreover, in this embodiment, when the recording position returns from Layer 2 to Layer 1 for recording management information, the internal/external power ratio γ is not used and only the last laser power Pwr2 in Layer 2 is divided by the interlayer power ratio α to obtain the power in recording the management information. However, when the recording position is near the finishing end of the data zone in Layer 2, the internal/external power ratio γ may be multiplied to correct the difference in recording characteristics of the inner and outer peripheries. Also, based on Pwp2 in and Pwp2out, the transition condition of the internal/external power ratio in the radius direction is approximated. From the approximated internal/external power ratio γ (x) (X: position in the radius direction), the internal/external power ratio γ (xn) in the final recording position Xn in Layer 2 may be obtained, and the obtained internal/external power ratio γ (xn) may be used to calculate Pwr1=(Pwr2/α)×γ(xn), thereby setting the laser power Pwr1 in recording of management information.

Note that such correction based on the internal/external power ratio γ in recording the management information may also be applied in Embodiments 1 and 2. However, in this case, such process is required that the OPC using the outer disc drive zone is further executed to obtain and the internal/external power ratio γ or γ (x).

The embodiment mode and embodiments of the present invention have been described, but the present invention is not limited to the above and can have other various modifications.

For example, in the above, the DVD+R and the optical disc drive therefor are exemplified, but of course the present invention can be applied to other optical discs such as a DVD-RW and recording and reproducing apparatuses therefor.

Further, in the above, the OPC process flow shown in FIGS. 5 and 6 is used but other OPC process flow can be used instead.

Further, in the above, the optical disc having two recording layers arranged on one side is exemplified, but the number of the recording layers is not limited to two. The present invention can also be applied to an optical disc having three or more recording layers arranged on one side and a recording and reproducing apparatus therefor. In this case, for example, the interlayer power ratio α or the interlayer power disparity ΔPa between the adjacent recording layers in the layer direction is obtained, and by using this, the power setting in interlayer transition is performed. Further, in a case of an optical disc where the recording position skips from the outer periphery to the inner periphery in interlayer transition as in Embodiment 3, the internal/external power ratio γ or the inner/outer power disparity ΔPb for each layer is obtained, and by using the interlayer power ratio α or the interlayer power disparity ΔPa and the internal/external power ratio γ or the internal/external power disparity ΔPb, the power setting in interlayer transition is performed.

Furthermore, the present invention can also be applied to not only an optical disc having recording layers arranged only on one side but also an optical disc having recording layers arranged on both sides by bonding or the like and its recording and reproducing apparatus. Moreover, the area format, the track spiral direction for each layer, and the like are not limited to the embodiment mode.

Embodiments of the present invention can appropriately have various modifications within the scope of the technical idea indicated by the scope of claims.

What is claimed is:

1. An optical recording and reproducing apparatus for recording information on an optical recording medium having plural recording layers arranged in a laminating direction and reproducing the information from the optical recording medium, comprising:
laser power setting means for obtaining a ratio α between a laser beam optimum power for a recording layer n and a laser beam optimum power for another recording layer m, and setting, when a recording position transits from the recording layer n to the recording layer m, a power obtained by performing a correction based on the power ratio α on a laser beam power Pwn before the transition as a laser beam power Pwm after the transition.

2. An optical recording and reproducing apparatus according to claim 1, wherein the laser power setting means further obtains, for a predetermined recording layer, a ratio γ between a laser beam optimum power at a recording area start position of the recording layer and a laser beam optimum power at the recording area end position of the recording layer, and when the recording position transits from the recording layer n to the recording layer m, obtains the laser power Pwm after the transition by performing a correction based on the ratio γ as well as the power ratio α.

3. An optical recording and reproducing apparatus according to claim 2, wherein the ratio γ is obtained for one of the recording layer n and the recording layer m.

4. An optical recording and reproducing apparatus according to claim 1, wherein the laser power setting means further obtains, for a predetermined recording layer, a disparity ΔPb between a laser beam optimum power at a recording area start position of the recording layer and a laser beam optimum power at the recording area end position of the recording layer, and when the recording position transits from the recording layer n to the recording layer m, obtains the laser power Pwm after the transition by performing a correction based on the disparity ΔPb as well as the power ratio α.

5. An optical recording and reproducing apparatus according to claim 4, wherein the disparity ΔPb is obtained for one of the recording layer n and the recording layer m.

6. An optical recording and reproducing apparatus for recording information on an optical recording medium having plural recording layers arranged in a laminating direction and reproducing the information from the optical recording medium, comprising:
laser power setting means for obtaining a disparity ΔPa between a laser beam optimum power for a recording layer n and a laser beam optimum power for another recording layer m, and setting, when a recording position transits from the recording layer n to the recording layer m, a power obtained by performing a correction based on the optimum power disparity ΔPa on a laser beam power Pwn before the transition as a laser beam power Pwm after the transition.

7. An optical recording and reproducing apparatus according to claim 6, wherein the laser power setting means further obtains, for a predetermined recording layer, a ratio γ between a laser beam optimum power at a recording area start position of the recording layer and a laser beam optimum power at the recording area end position of the recording layer, and when the recording position transits from the recording layer n to the recording layer m, obtains the laser power Pwm after the transition by performing a correction based on the ratio γ as well as the optimum power disparity ΔPa.

8. An optical recording and reproducing apparatus according to claim 7, wherein the ratio γ is obtained for one of the recording layer n and the recording layer m.

9. An optical recording and reproducing apparatus according to claim 6, wherein the laser power setting means further obtains, for a predetermined recording layer, a disparity ΔPb between a laser beam optimum power at a recording area start position of the recording layer and a laser beam optimum power at the recording area end position of the recording layer, and when the recording position transits from the recording layer n to the recording layer m, obtains the laser power Pwm after the transition by performing a correction based on the disparity ΔPb as well as the optimum power disparity ΔPa.

10. An optical recording and reproducing apparatus according to claim 9, wherein the disparity ΔPb is obtained for one of the recording layer n and the recording layer m.

11. An optical recording and reproducing apparatus for recording information on an optical recording medium having plural recording layers arranged in a laminating direction and reproducing the information from the optical recording medium, comprising:
a control circuit for obtaining a laser beam optimum power for a recording layer n and a laser beam optimum power for another recording layer m, and setting, when a recording position transits from the recording layer n to the recording layer m, a laser beam power. Pwm after the transition based on the optimum power for the recording layer n and the optimum power for the recording layer m from a laser beam power Pwn before the transition.

12. An optical recording and reproducing apparatus according to claim 11, wherein the control circuit obtains a ratio α between the optimum power for the recording layer n and the optimum power for the recording layer m, and sets a power obtained by performing a correction based on the ratio α on the laser beam power Pwn before the transition as the laser beam power Pwm after the transition.

13. An optical recording and reproducing apparatus according to claim 11, wherein the control circuit obtains a disparity ΔPa between the optimum power for the recording layer n and the optimum power for the recording layer m, and sets a power obtained by performing a correction based on the disparity ΔPa on the laser beam power Pwn before the transition as the laser beam power Pwm after the transition.

14. An optical recording and reproducing apparatus according to claim 12 or 13, wherein the control circuit further obtains, for a predetermined recording layer, a ratio γ between a laser beam optimum power at a recording area start position of the recording layer and a laser beam optimum power at the recording area end position of the recording layer, and when the recording position transits from the recording layer n to the recording layer m, obtains the laser power Pwm after the transition by performing a correction based on the ratio γ as well as the power ratio α or the optimum power disparity ΔPa.

15. An optical recording and reproducing apparatus according to claim 14, wherein the ratio γ is obtained for one of the recording layer n and the recording layer m.

16. An optical recording and reproducing apparatus according to claim 12 or 13, wherein the control circuit further obtains, for a predetermined recording layer, a disparity ΔPb between a laser beam optimum power at a recording area start position of the recording layer and a laser beam optimum power at the recording area end position of the recording layer, and when the recording position transits from the recording layer n to the recording layer m, further obtains the laser power Pwm after the transition by performing a correction based on the disparity ΔPb as well as the power ratio α or the optimum power disparity ΔPa.

17. An optical recording and reproducing apparatus according to claim 16, wherein the disparity ΔPb is obtained for one of the recording layer n and the recording layer m.
